(19) United States
(12) Patent Application Publication
(10) Pub. No.: US 2004/0093615 A1
(43) Pub. Date: May 13, 2004

(54) PVR credits by user

(75) Inventors: Stephen B. Boston, Cedar Park, TX (US); Michael Wayne Brown, Georgetown, TX (US); Michael A. Paolini, Austin, TX (US)

Correspondence Address: BRACEWELL & PATTERSON, L.L.P., P.O. BOX 969, AUSTIN, TX, 78767-0969, US

(73) Assignee: International Business Machines Corporation, Armonk, NY

(21) Appl. No.: 10/290,224

(22) Filed: Nov. 7, 2002

(51) Int. Cl. H04N 5/445; H04N 7/173

(52) U.S. Cl. 725/46; 725/97

(57) ABSTRACT

The present invention provides a method and system for crediting a specific user of a personal video recorder (PVR) system. The one or more current users of a PVR system are identified. Based on the activity being performed by the users, the users' accounts are credited. The activity may be watching advertising or programming, to allowing the PVR provider to distribute the users' viewing habits, or completing surveys. Additionally, users may belong to a user group that may be credited based on the activity performed. Specific combinations of users may incur bonuses or premiums based on the combination of users.

### CROSS REFERENCE TO RELATED APPLICATIONS

The present application shares specification text and figures with the following co-pending applications, which were filed concurrently with the present application: application Ser. No. ______(Attorney Docket Number AUS920020416US1) “Fee-Based Programming Charge Based on Content Viewed by User;” and application Ser. No. ______(Attorney Docket Number AUS920020418US1) “User Specific Cable/Personal Video Recorder Preferences.” The content of the co-pending applications are incorporated herein by reference.

### BACKGROUND OF THE INVENTION

1. Technical Field

The invention relates generally to the field of data processing, more particularly to personal video recorders and cable systems, and still more particularly to identifying a current user of a personal video record system and crediting said user based on the type of activity being performed.

2. Description of the Related Art

The use of personal video recorders (PVRs) and cable television systems has become common-place in homes. To a large extent, cable providers derive income from advertisements viewed by home users making it important for cable providers to know what users are watching and to entice users to watch certain types of programming or complete surveys. By knowing how many homes view a specific programming, cable providers are able to charge advertising rates accordingly. To provide incentives for people to watch a particular programming, some cable companies have provided credits for a home account when a particular program was viewed.

While the term cable is utilized in the Specification of the present invention, the term is meant to include all forms and providers of electronic video data.

However, the current solutions do not provide a cable provider with information about the individual viewer on programming. Most cable systems in homes are shared by one or more users. It would be advantageous to cable providers to know which specific users are operating cable television systems. Application Ser. No. ______ entitled “User Specific Thumbs Up/Down” teaches a method of identifying a specific user of a PVR system and is incorporate by reference. The PVR provider may use this information to charge higher advertising rates based on enticing a higher number of users, specific types of users (such as males age 18-25) to view specific programming. Therefore there is a need for crediting specific users of a PVR system.

### SUMMARY OF THE INVENTION

The present invention provides a method and system for crediting a specific user of a personal video recorder (PVR) system. The one or more current users of a PVR system are identified. Based on the activity being performed by the users, the users' accounts are credited. The activity may be watching advertising or programming, allowing the PVR provider to distribute the users' viewing habits, or completing surveys. Additionally, users may belong to a user group that may be credited based on the activity performed. Specific combinations of users may incur bonuses or premiums based on the combination of users.

### DESCRIPTION OF THE DRAWINGS

The novel features believed characteristic of the invention are set forth in the appended claims. The invention itself, however, as well as the preferred modes of use, further objects and advantages thereof, will best be understood by reference to the following detailed description of an illustrative embodiment when read in conjunction with the accompanying drawings, wherein:

FIG. 1 is an exemplary block diagram illustrating a personal video record receiver as may be utilized by the present invention;

FIG. 2 is a schematic diagram depicting an exemplary system in which the present invention may be implemented; and

FIG. 3 is a flow chart illustrating a set of steps for crediting a user for watching a particular type of programming.

### DESCRIPTION OF THE PREFERRED EMBODIMENT

Referring now to the drawing figures, in which like numerals indicate like elements or steps throughout the several views, the preferred embodiment of the present invention will be described. In general, the present invention provides for crediting specific users of a PVR system.

While the term cable is utilized in the Specification of the present invention, the term is meant to include all forms and providers of electronic video data.

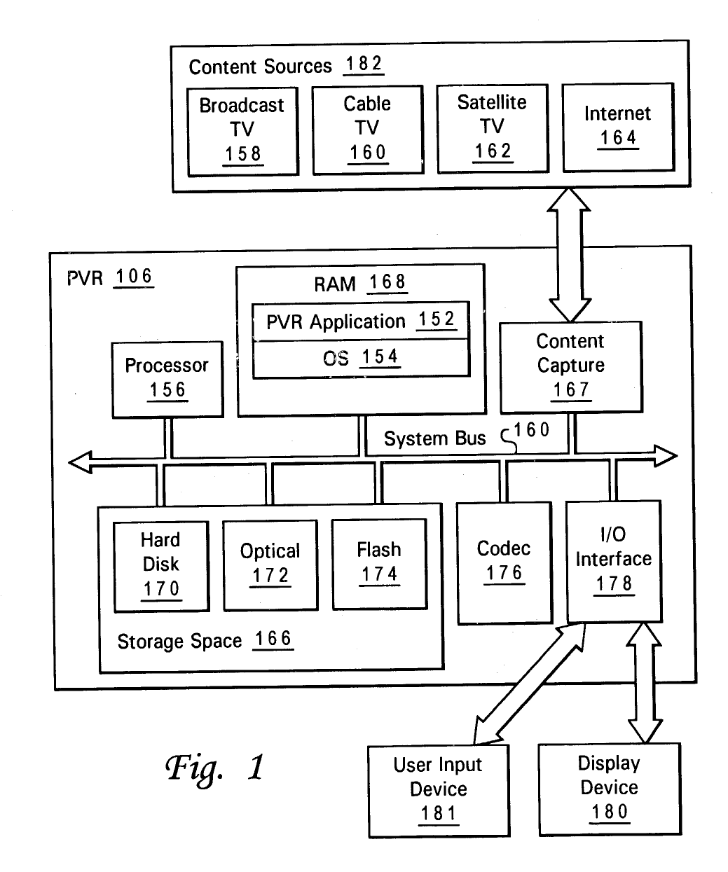

With reference now to FIG. 1, an exemplary block diagram illustrating a personal video recorder system as may be utilized by the present invention is shown. FIG. 1 sets forth a block diagram of automated computing machinery comprising a PVR 106 according to an exemplary embodiment of the present invention. PVR 106 of FIG. 1 includes at least one computer processor 156 as well as random access memory (RAM) 168. Stored in RAM 168 is a PVR application program 152 implementing inventive steps of the present invention.

Also stored in RAM 168 is an operating system (OS) 154. Embodiments of the present invention are directed towards personal video preference settings for multiple users. It will occur to readers skilled in the art that much of the work of administering user accounts for many users may be downshifted to a multi-user operating system such as Unix, Linux, or Microsoft NT_{TM}. The multi-user features of typical embodiments of the present invention, however, tend to be features of application software. PVRs according to embodiments of the present invention, therefore, may use single-user operating systems, such as Microsoft's Disk Operating System or “DOS,” as well as multi-user operating systems, or even operating systems developed as special purpose systems for use in PVR according to this invention. RAM 168 in conjunction with OS 154 are utilized to carry out computer program instructions of the present invention.

PVC 106 includes storage space 166 for programming. Storage space 166 may be implemented as hard disk space 170, optical drive space 172, electrically erasable programmable read-only memory space (EEPROM or Flash memory) 174, RAM drives (not shown), or as any other type of computer memory capable of receiving and storing recorded content.

In a preferred embodiment, RAM 168 includes storage space for storing user specific preferences and/or account information. Additionally, RAM 168 contains application software required to obtain and verify the current one or more users of PVR 106.

The example PVR 106 includes a subsystem for content capture 167. The subsystem for content capture 167 is implemented in typical embodiments according to content sources 182 and may include in various embodiments a broadcast television tuner for receipt of broadcast television 158, a cable box for receipt of cable television 160, a satellite receiver for receipt of satellite television 162, and an Internet connection for downloading recordable content from the Internet 164.

PVR 106 includes a codec 176, which may take the form of a video card logically connected to the system bus of a personal computer, or other forms as will occur to those of skill in the art. Codec 176 provides video and audio output from recorded programming in storage space 166 to an input/output interface 178. Additionally, codec 176 may also provide changes in video compression or video quality as needed in particular instances. The input/output interface provides video and audio output to a display device 180. In the case of PVRs implemented with connection to televisions, the display device 180 is a television. In the case of PVRs implemented as general purpose computers, the display device is often implemented as a computer screen. Display device 180 is any device, as will occur to those of skill in the art, capable of displaying video and audio content.

PVC 106 includes an input/output interface 178. The input/output interface 178 in PVRs implemented as general purpose computers is a computer interface including, for example, conventional software drivers and computer hardware for controlling output to display devices 180 such as computer screens, as well as user input from user input devices 181 such as computer keyboards and computer mice. In the case of PVRs as set top boxes, an input/output interface 178 comprises, for example, software drivers and computer hardware for controlling displays on display devices 180 such as television screens and user input from user input devices 181 such as remote control devices.

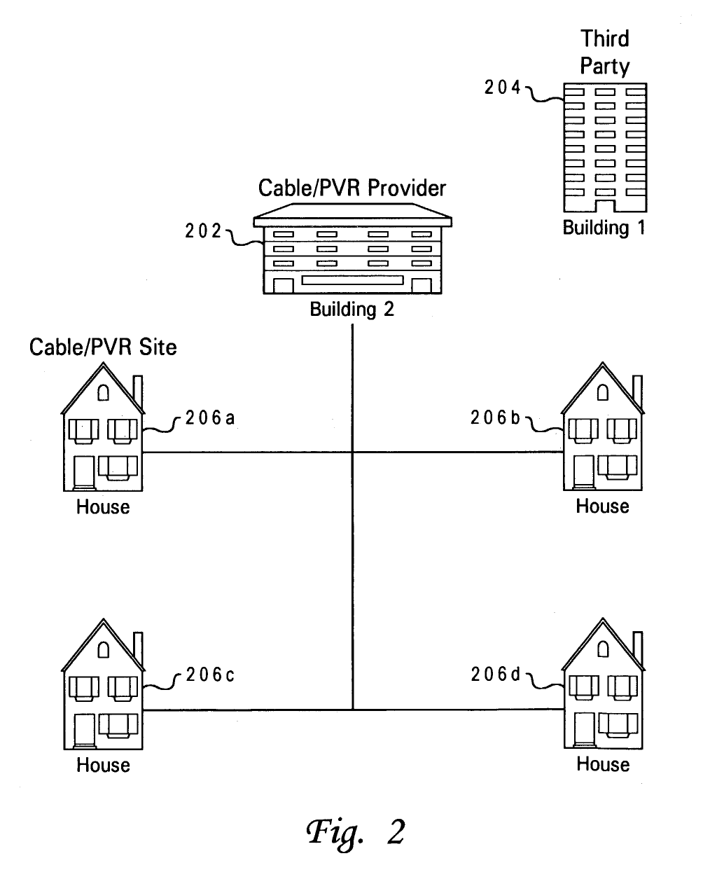

Now referring to FIG. 2, a schematic diagram depicting an exemplary system in which the present invention may be implemented is provided. PVR provider 202 is logically connected to one or more PVR units (not shown, but substantially similar to PVR 106 in FIG. 1) located in houses 206a-d. The means of connecting PVR provider 202 to houses 206a-d may take the form of physical lines, such as coaxial cable, or wireless transmission.

Houses 206a-d each may have a varying number of users for the PVR system. Each PVR system is capable of identifying a current user or set of users in a manner described in related patent application 09/______ entitled “User Specific Preferences.”

PVR provider 202 maintains information on accounts for each house 206a-d. In a preferred embodiment, the account also includes user specific information such as age, sex, and other information of value in selecting target populations for types of programming.

In an exemplary embodiment, PVR provider 202 collects data about user viewing habits and/or survey information and transmits the data to third party 204. Additionally, in yet another exemplary embodiment, PVR provider 202 enables third party 204 direct access to user habits and/or survey information via a logical connection such as the Internet.

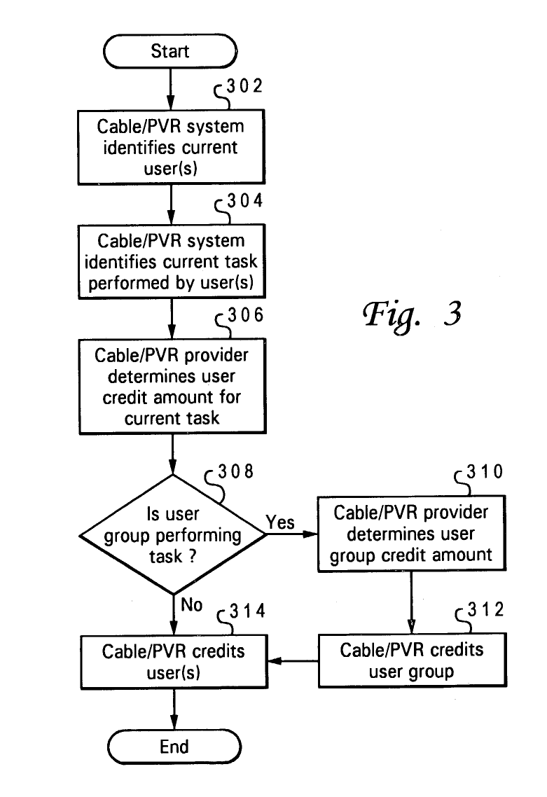

With reference now to FIG. 3, a flow chart illustrating a set of steps for crediting a user for watching a particular type of programming is shown. The process begins as depicted at step 302 with the PVR system identifying the current one or more users. In a preferred embodiment, the PVR system transmits the identity of the one or more users to the PVR provider. In alternative embodiments, the PVR system does not transmit the identity of the one or more current users, but maintains the information locally.

As the process continues and as illustrated at step 304, the PVR system identifies the current task being performed by the one or more current users. The current task may include watching advertisements or other aired programming, allowing the PVR system to distribute a viewer's watching habits (i.e. Neilson ratings), or completing surveys.

Upon identifying the current one or more users (step 302) and the current task (step 304), the PVR provider determines an amount to credit the individual one or more users for the current task as illustrated at step 306. The amount to credit the user as an individual takes the form of the equation: Creditᵤₛₑᵣ=Task(u)+Bonus(u) wherein Task(u) is the amount for completing the task by the user as an individual and Bonus(u) represents any bonus a viewer may receive for the completion of previous tasks such as previously completing a specific number of surveys or by belonging to a certain demographic. Those skilled in the art will readily recognize the determination of how much to credit a user may take on the form of other equations without departing from the spirit and scope of the present invention.

Continuing on to step 308, the PVR provider determines if a user group is performing the current task. The determination of a user group is valuable because certain types of activities are more valuable if completed by a group as opposed to the individuals separately. For example, a toy commercial for children viewed by a child and parent is more valuable than if each viewed the commercial separately. If the PVR provider determines a user group is performing the task, the process continues to step 310, otherwise the process continues to step 314.

Step 310 depicts the PVR provider determining an amount to credit a user group for a particular task. Similar to the determination of a credit for an individual user as described in conjunction with step 306, the amount to credit a group of users is represented by the equation: Credit_{group}=Task(g)+Bonus(g) wherein Task(g) represents the amount a particular type of group receives for performing the task and Bonus(g) represents any additional credit for the group for the completion of previous tasks. One of ordinary skill in the art will readily recognize the group credit could take the form of other equations known in the art for determining an amount to credit a user. For example, additional terms may be added to the equation for a Task value as a function of the individual user and/or group.

Following a determination of an amount to credit a user group (step 310), the process continues to step 312 which illustrates the PVR provider crediting the user group. Crediting the user group means crediting the users within a particular group by a premium for performing the task as a group. The account for each user in the group is adjusted according to the amount determined at step 310. In a preferred embodiment, the account information is maintained by the PVR provider. The PVR provider credits the accounts of each user by the determined amount. In alternative embodiments, the account information is maintained by the PVR system in communication with the PVR provider.

If a determination is made at step 308 that no user group is performing the current task or after a user group has been credited (step 312), the process continues to step 314 depicting the PVR provider crediting the current one or more users as individuals. The account for each one or more users is adjusted by the amount determined at step 306.

It will be understood from the foregoing description that modifications and changes maybe made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of allocating credits to users of a personal video recorder (PVR) system, wherein said PVR system is utilized by more than one user, said method comprising the steps of:
identifying one or more current users of said PVR system;
determining an amount to credit said one or more current users for a task; and
crediting an account for said one or more current users by said determined user amount.

2. The method of claim 1, further comprising the steps of:
determining if said one or more current users belong to a user group;
in response to determining said current one or more users belong to said user group, determining an amount to credit said user group; and
in response to determining said one or more current users belongs to said user group, crediting said user group by said determine user group amount.

3. The method of claim 1, wherein the step of determining an amount to credit said one or more current users further comprises the steps of:
determining a type of activity being performed by said one or more current users; and
determining said amount to credit said one or more current users based on said type of activity being performed.

4. The method of claim 2, wherein the step of in response to determining said current one or more users belong to said user group, determining an amount to credit said user group further comprises the steps of:
a type of activity being performed by said one or more current users; and
determining said amount to credit said user group based on said type of activity being performed.

5. The method of claim 1, wherein said amount to credit said one or more current users is determined by the equation:
Creditᵤₛₑᵣ=Task(u)+Bonus(u)
wherein Task(u) is an amount for completing said task by said user as an individual and Bonus(u) represents a potential bonus for said user.

6. The method of claim 2, wherein said amount to credit said user group is determined by the equation:
Credit_{group}=Task(g)+Bonus(g)
wherein Task(g) represents an amount said user group receives for performing said task and Bonus(g) represents any additional credit for performing said task.

7. A system for allocating credits to users of a personal video recorder (PVR) system, wherein said PVR system is utilized by more than one user, said system comprising:
means for identifying one or more current users of said PVR system;
means for determining an amount to credit said one or more current users for a task; and
for crediting an account for said one or more current users by said 8 determined user amount.

8. The system of claim 7, further comprising:
means for determining if said one or more current users belong to a user group;
means for in response to determining said current one or more users belong to said user group, determining an amount to credit said user group; and
means for in response to determining said one or more current users belongs to said user group, crediting said user group by said determine user group amount.

9. The system of claim 7, wherein the means for determining an amount to credit said one or more current users further comprises:
means for determining a type of activity being performed by said one or more current users; and
means for determining said amount to credit said one or more current users based on said type of activity being performed.

10. The system of claim 8, wherein the means for in response to determining said current one or more users belong to said user group, determining an amount to credit said user group further comprises:
means for determining a type of activity being performed by said one or more current users; and
means for determining said amount to credit said user group based on said type of activity being performed.

11. The system of claim 7, wherein said amount to credit said one or more current users is determined by the equation
Creditᵤₛₑᵣ=Task(u)+Bonus(u)
wherein Task(u) is an amount for completing said task by said user as an individual and Bonus(u) represents a potential bonus for said user.

12. The system of claim 8, wherein said amount to credit said user group is determined by the equation:
Credit_{group}=Task(g)+Bonus(g)
wherein Task(g) represents an amount said user group receives for performing said task and Bonus(g) represents any additional credit for performing said task.

13. A computer program product for allocating credits to users of a personal video recorder (PVR) system, wherein said PVR system is utilized by more than one user, said computer program product comprising:
means for identifying one or more current users of said PVR system;
means for determining an amount to credit said one or more current users for a task; and
means for crediting an account for said one or more current users by said determined user amount.

14. The computer program product of claim 13, further comprising:
means for determining if said one or more current users belong to a user group;
means for in response to determining said current one or more users belong to said user group, determining an amount to credit said user group; and
means for in response to determining said one or more current users belongs to said user group, crediting said user group by said determine user group amount.

15. The computer program product of claim 13, wherein the means for determining an amount to credit said one or more current users further comprises:
means for determining a type of activity being performed by said one or more current users; and
means for determining said amount to credit said one or more current users based on said type of activity being performed.

16. The computer program product of claim 14, wherein the means for in response to determining said current one or more users belong to said user group, determining an amount to credit said user group further comprises:
means for determining a type of activity being performed by said one or more current users; and
means for determining said amount to credit said user group based on said type of activity being performed.

17. The computer program product of claim 13, wherein said amount to credit said one or more current users is determined by the equation:
Creditᵤₛₑᵣ=Task(u)+Bonus(u)
wherein Task(u) is an amount for completing said task by said user as an individual and Bonus(u) represents a potential bonus for said user.

18. The computer program product of claim 14, wherein said amount to credit said user group is determined by the equation:
Credit_{group}=Task(g)+Bonus(g)
wherein Task(g) represents an amount said user group receives for performing said task and Bonus(g) represents any additional credit for performing said task.
